(19) United States
(12) Patent Application Publication
(10) Pub. No.: US 2003/0040246 A1
(43) Pub. Date: Feb. 27, 2003

(54) Method of manufacturing cathode structure and color cathode ray tube

(75) Inventors: Toshikazu Sugimura, Ohtsu-shi (JP); Yoshiyuki Tanaka, Ohtsu-shi (JP)

Correspondence Address: SUGHRUE MION, PLLC, 2100 PENNSYLVANIA AVENUE, N.W., WASHINGTON, DC, 20037, US

(73) Assignee: NEC KANSAI, LTD.

(21) Appl. No.: 10/223,325

(22) Filed: Aug. 20, 2002

(30) Foreign Application Priority Data
Aug. 21, 2001 (JP) 249790/2001

(51) Int. Cl. H01J 9/04

(52) U.S. Cl. 445/36; 445/51; 313/346 DC

(57) ABSTRACT

A mixed body made of at least nickel powder and electron emission agent powder is sintered through a hot isostatic pressing process to form a sintered body, and a cathode pellet is formed from the sintered body. Then, the cathode pellet Is inserted into a cup. Then, the cathode pellet and the cup are clamped between upper and lower welding electrodes each having approximately the same diameter as the cathode pellet, and the cathode pellet and the cup are subjected to resistance welding in this clamped state. Then, an assembly of the cathode pellet and the cup is inserted and fixed in an end portion of a sleeve, and a heater is inserted into the sleeve.

### BACKGROUND OF THE INVENTION

The present invention relates to a method of manufacturing a cathode structure which can achieve a long life even if it is operated with a large current. The present invention also relates to a color cathode ray tube (CRT) incorporating the cathode structure.

A known cathode structure which was proposed by the present inventor is disclosed in Japanese Unexamined Patent Publication No. 2001-6521A. In this earlier technique, the inventor attempted to overcome the disadvantage that an oxide cathode rapidly deteriorates at high current densities. The cathode structure of the earlier technique will hereafter be referred to as the related cathode structure.

Now, a method of manufacturing the related cathode structure will be described with reference to FIG. 1.

In a first step, nickel powder, scandium oxide powder and electron emission agent powder are sintered by a hot isostatic pressing process, whereby a sintered body is produced. In a second step, a cathode pellet 71 having a disk-like shape of diameter 1.1 mm and thickness 0.22 mm is out out of the sintered body. In a third step, the cathode pellet 71 is accommodated Into a cup 72 of inside diameter 1.1 mm, depth 0.2 mm and thickness 50 μm, and the cathode pellet 71 and the cup 72 are welded to each other.

The third step will be described in detail. First of all, the cathode pellet 71 is inserted into the cup 72. At this time, heat conduction deteriorates if a space lies between the bottom of the cathode pellet 71 and the cup 72. Accordingly, to improve heat conduction, the space is eliminated by inserting the cathode pellet 71 into the cup 72 under strong pressure. Furthermore, the bottom of the cup 72 is irradiated with a laser beam in the direction of the cathode pellet 71 so that the cathode pellet 71 and the cup 72 are welded to each other, thereby prevent the cathode pellet 71 from moving up at a later time. Then the cup 72 In which the cathode pellet 71 is fitted is inserted into an end portion of a sleeve 73. Then, the periphery of the end portion of the sleeve 73 is subjected to resistance welding. Incidentally, the cup 72 is made of a nickel-chromium alloy of 80% nickel and 20% chromium. The nickel-chromium alloy of the cup 72 has the following merit.

For electron emission, it is necessary to reduce BaO with a reducing agent and generate Ba atoms. In this cathode structure 70, chromium atoms are thermally diffused into the cathode pellet 71 from the cup 72 heated by a heater 74, whereby BaO in the electron emission agent is reduced to generate Ba atoms. Electrons are emitted from the generated Ba atoms. At the same time, a byproduct Ba₃(Cr₄)₂ is formed, however, this byproduct Ba₃(Cr₄)₂, is low in electrical resistance and does not preclude electron emission.

According to the above-described construction, it is possible to achieve the cathode structure 70 for which the electron emission is not lowered even if it is operated for more than twenty thousand hours at an operating temperature of 780° C. with a large current density exceeding 3 A/cm². Although the related cathode structure 70 has practically satisfactory performance, the present invention aims to make the related cathode structure 70 more easy to use by eliminating the variation in characteristic in the related cathode structure 70.

The related cathode structure 70 needs the step of eliminating the space by inserting the cathode pellet 71 into the cup 72 under strong pressure, and the step of laser-welding the peripheral surface of the cup 72 from the bottom of the cup 72 to prevent the cathode pellet 71 from moving up at a later time.

Laser welding is preferable because of a non-contact method free from contamination. However, several points at the bottom surface of the cup 72 need to be welded because It is difficult to weld the whole area of the bottom by laser welding. Unfortunately, the portions of the bottom of the cup 72 that are irradiated with a laser beam tend to become thicker than the other portions when they are melted and solidified. Accordingly, there is a case where a space occurs between the cathode pellet 71 and the cup 72 owing to laser welding although no space is seen before laser welding. If this space occurs, the temperature of the cathode pellet 71 becomes uneven although the temperature of the heater 74 does not change. There is also a method of irradiating the whole area of the bottom of the cup 72 with a defocused laser beam, however, this method cannot be easily used, because it is likely that the temperature of the whole of the cathode pellet 71 rises to decompose the electron emission agent.

### SUMMARY OF THE INVENTION

The invention aims to solve the problem of the above-described method of manufacturing the related cathode structure 70 and eliminate the temperature variation of the cathode pellet 71 so as to realize a color cathode ray tube (CRT) with high-luminance and long-life, free from variation in characteristic, which will be achieved by incorporating such a cathode structure.

In a manufacturing method for a cathode structure according to the present invention, at first a cathode pellet and a cup are clamped between upper and lower welding electrodes each having approximately the same diameter as the cathode pellet, and are subjected to resistance welding in this clamped state. Thus the cathode pellet and the bottom of the cup are welded on a surface-to-surface basis without space. Since no space occurs between the cathode pellet and the bottom of the cup, the temperature of the cathode pellet does not become uneven. There is a risk that if welding current flows into the portion of the cathode pellet which emits electrons, i.e., the central portion of Its electron emission surface which corresponds to an opening of the first grid, the electron emission characteristics of the cathode pellet deteriorate. Accordingly, the central portion is given a shape having an escape from the upper welding electrode, or an insulator is embedded in the central portion.

A suitable material of the cup can be any one kind selected from the following materials including nickel-chromium alloy, nickel-magnesium-chromium alloy, nickel-magnesium-silicon-chromium alloy, nickel-magnesium-tungsten alloy, and nickel-magnesium-silicon-tungsten alloy. in the case where the cup is made of the nickel-chromium alloy, chromium serves as a reducing agent. In this case, there is the advantage that a byproduct Ba₃(Cr₄)₂ is low in electrical resistance and does not preclude electron emission. In the case where the cup is made of any one kind of the followings, i.e. the nickel-magnesium-chromium alloy, the nickel-magnesium-silicon-chromium alloy, the nickel-magnesium-tungsten alloy and the nickel-magnesium-silicon-tungsten alloy, then the reducing agents will be magnesium, silicon, chromium and tungsten.

These reducing agents are strong in reducing force, and have the advantage that the operating temperature of the cathode structure becomes low. Incidentally, the coefficient of thermal conductivity of the nickel-chromium alloy is as low as about 17 W/m·K. Contrarily, the coefficient of thermal conductivity of any of the nickel-magnesium-chromium alloy, the nickel-magnesium-silicon-chromium alloy, the nickel-magnesium-tungsten alloy and the nickel-magnesium-silicon-tungsten alloy is as high as about 67 W/m·K, and this leads to the advantage that the temperature of the heater can be lowered.

It is possible to realize a high-luminance and long-life color CRT free from characteristic variation by incorporating thereinto the cathode structure of the invention.

According to a first aspect of the present invention, a method of manufacturing a cathode structure Is characterized by sintering a mixed body made of at least nickel powder and electron emission agent powder through a hot isostatic pressing process to form a sintered body, then forming a cathode pellet from the sintered body, then inserting the cathode pellet into a cup, then clamping the cathode pellet and the cup between upper and lower welding electrodes each having approximately the same diameter as the cathode pellet and subjecting the cathode pellet and the cup to resistance welding in this clamped state, then inserting and fixing an assembly of the cathode pellet and the cup In an and portion of a sleeve, and then inserting a heater into the sleeve.

According to a second aspect of the present invention. a method of manufacturing a cathode structure is characterized in that a central portion of an electron emission surface of the cathode pellet, which portion corresponds to an opening of a first grid, Is provided with an escape from a welding electrode so that the welding electrode is prevented from coming into contact with the central portion of the electron emission surface.

According to a third aspect of the present invention, a method of manufacturing a cathode structure is characterized in that an insulator is embedded in a central portion of an electron emission surface of the cathode pellet, which portion corresponds to an opening of a first grid, so that although the same clamping pressure as that applied to a peripheral portion of the electron emission surface is applied to the central portion thereof , welding current is prevented from flowing into the central portion of the electron emission surface.

According to a fourth aspect of the present invention, a method of manufacturing a cathode structure is characterized in that the cup is made of any one kind selected from the materials among nickel-chromium alloy, nickel-magnesium-chromium alloy, nickel-magnesium-silicon-chromium alloy, nickel-magnesium-tungsten alloy, and nickel-magnesium-silicon-tungsten alloy.

According to a fifth aspect of the present invention, a color cathode ray tube (CRT) is provided with a cathode structure manufactured by the method in the above-described first through fourth aspects.

### BRIEF DESCRIPTION OF THE DRAWINGS:

FIG. 1 is a partly cross-sectional perspective view of a related cathode structure;

FIG. 2 is a perspective view of a cathode pellet according to the present invention;

FIG. 3 is a perspective view of a cup according to the present invention;

FIG. 4 is an explanatory view of the welding between the cathode pellet and the cup according to the present invention;

FIG. 5 is a perspective view of a cup-mounted cathode pellet according to the present invention;

FIG. 6 is a perspective view of one example of an upper electrode according to the present invention;

FIG. 7 is a perspective view of another example of the upper electrode according to the present invention; and

FIG. 8 is a partly cross-sectional perspective view of one example of a cathode structure according to the present invention.

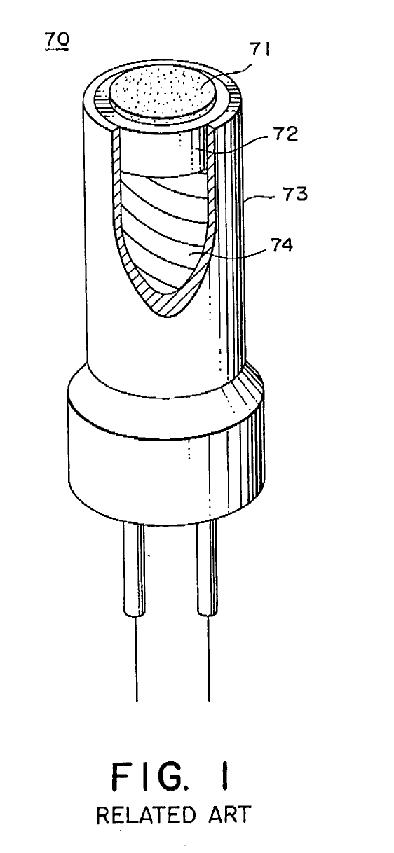

### DESCRIPTION OF THE PREFERRED EMBODIMENT

Hereinbelow, description will be made about one embodiment of a method of manufacturing a cathode structure according to the invention.

Incidentally, the n-th power of 10 is mentioned as 10En, and the -n-th power of 10 is mentioned as 10E-n. 100 g of nickel powder of 5 μm In average particle size, 6 g of scandium oxide powder, and 60 g of coprecipitated barium-strontium-calcium carbonate which contains barium, strontium and calcium at a mole ratio of 50:40:10 and has an average particle size of 1-2 μm are uniformly mixed by a dry mixer. Among these powders, the coprecipitated barium-strontium-calcium carbonate becomes an electron emission agent.

A cylindrical molded object is produced by press-molding the mixed powder at normal temperature. In this step, the nickel powder is not yet sintered.

The molded object is vacuum-enclosed in a glass-made capsule. The degree of vacuum at this time is about 10E-4 Pa. While a vacuum is being drawn, gases are ejected from the molded object and the capsule at about 500° C.

The molded object enclosed in the capsule is placed into a hot isostatic pressing process machine, and Is subjected to sintering with a maximum pressure of 130 MPa and a maximum temperature of 1,100° C. under the condition that the molded object is retained at the maximum temperature for 60 minutes. Only the nickel powder Is sintered. The scandium oxide powder and the coprecipitated barium-strontium-calcium carbonate are not sintered, and are placed into the state of being retained in pores in a network structure formed by the nickel particles open core. The pores are open cores each of which is joined to an adjacent one. Gases and substances in the pores travel from each of the pores to an adjacent one, and can reach the surface of the sintered body. Since the above-described high pressure is applied during sintering, the coprecipitated barium-strontium-calcium carbonate is not decomposed into oxides.

After cooling, the capsule is taken out of the hot isostatic pressing process machine, and the sintered body is taken out of the capsule.

First, the sintered body is sliced with a green carborandom (GC) 200# wheel, thereby preparing a cathode wafer of thickness 0.5 mm. Then, both surfaces of the cathode wafer are subjected to surface grinding with a cubic boron nitride (CBN) 1000# grinding stone so that the thickness of the cathode wafer becomes 0.22 mm. Then, the electron emission surface of the cathode wafer is polished with diamond slurry of particle size of 1 μm, thereby removing nickel film adhered to the electron emission surface. Thus, the electron emission surface becomes a mirror surface of surface roughness 1 μm or less. The thickness of the cathode wafer is not substantially changed by the polishing of the electron emission surface.

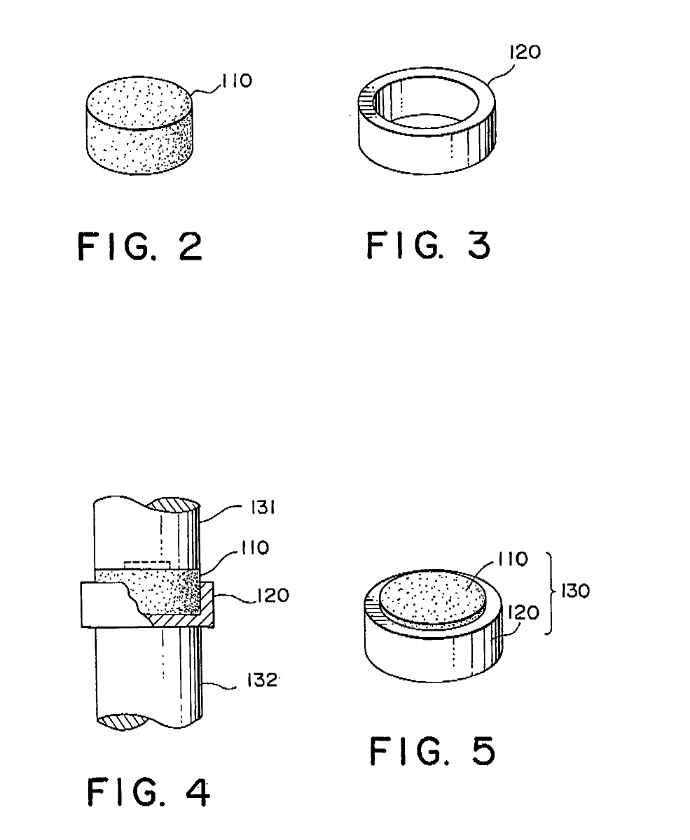

Then, the step of punching the cathode wafer with a punch and die made of cemented carbide is carried out. In this step, a cathode pellet 110 (refer to FIG. 2) having a disk-like shape of diameter 1.1 mm and thickness 0.22 mm as shown in FIG. 2 is obtained.

In addition, a nichrome alloy sheet (80% nickel and 20% chromium) of thickness 50 μm is subjected to drawing, whereby a cup 120 of inside diameter 1.1 mm and depth 200 μm (refer to FIG. 3) is obtained, The cathode pellet 110 Is fitted into this cup 120 without space.

Then, the cathode pellet 110 is inserted into the cup 120 as shown in FIG. 4. A cup-mounted cathode pellet 130 is clamped between an upper electrode 131 and a lower electrode 132 made of tungsten each having a welding surface of diameter 1.1 mm. By causing a large current to flow in the upper electrode 131 and the lower electrode 132, the bottom of the cathode pellet 110 and the bottom of the cup 120 are united by full-surface resistance welding. In this manner, the cup-mounted cathode pellet 130 (refer to FIG. 5) is obtained. Incidentally, the cathode pellet 110 and the cup 120 may also be laser-welded prior to resistance welding.

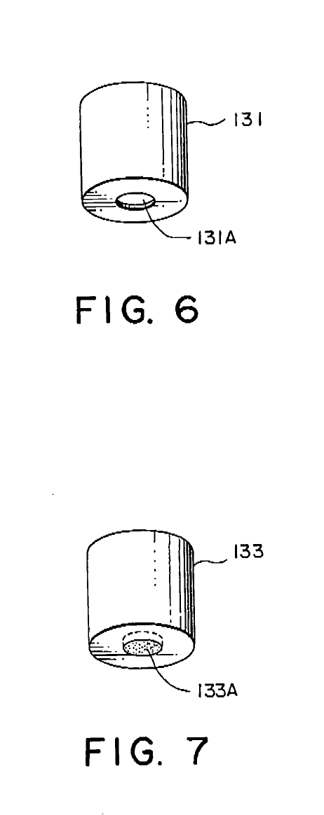

FIG. 6 is a perspective view of the upper welding electrode 131. A central portion (of diameter 0.5 mm) of the welding surface of the upper welding electrode 131 is formed as a concavity 131A of depth 0.1 mm so that the welding surface does not come into contact with the cathode pellet 110. This concavity 131A is provided so that welding current is prevented from flowing into the portion of the cathode pellet 110 which emits electrons, i.e., the central portion of the electron emission surface which corresponds to an opening of the first grid.

FIG. 7 is a perspective view showing another example of the upper welding electrode. As shown in FIG. 7, an insulator 133A of thickness 0.5 mm is embedded in a central portion (of diameter 0.5 mm) of the welding surface of an upper welding electrode 133. The welding surface is a planar surface having no variation. The insulator 133A suitably uses aluminum oxide. aluminum nitride and the like. The merit of the upper welding electrode 133 resides in the fact that mechanical pressure can be applied to the whole surface of the cathode pellet 110 without allowing welding current to flow into the central portion of the electron emission surface. Because mechanical pressure is applied to the whole surface of the cathode pellet 110, a welding failure does not easily occur between the cathode pellet 110 and the cup 120.

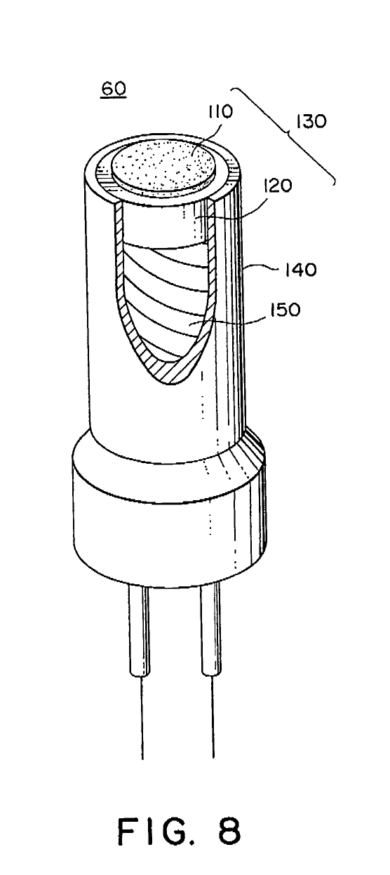

Then, as shown in FIG. 8, the cup-mounted cathode pellet 130 is inserted into an end portion of a sleeve 140. By applying laser welding or resistance welding to the periphery of the end portion of the sleeve 140, the cup-mounted cathode pellet 130 and the sleeve 140 are fixed by welding. Finally, a heater 150 is inserted into the sleeve 140 from below, whereby a cathode structure 160 according to the invention is completed.

The incorporation of the cathode structure of the invention into a color cathode ray tube (CRT) and the decomposition and activation of the cathode structure are performed in the same manner as the cathode structure of the related art. A multiplicity of cathode structures according to the related art and a multiplicity of cathode structures according to the invention were incorporated in color CRT, and were compared in terms of characteristic variation. This comparison showed that the cathode structures according to the invention were far smaller in characteristic variation than those according to the related art. The reason of this can be considered that a few of the cathode structures of the related art have spaces between cathode pellets and cups, whereas none of the cathode structures of the invention have spaces between cathode pellets and cups.

According to the invention, a cathode pellet and a cup are resistance-welded to each other in the state of being clamped between upper and lower welding electrodes each having approximately the same diameter as the cathode pellet. Because the cathode pellet and the bottom of the cup are welded on a surface-to-surface basis without space, the temperature of the cathode pellet does not become varied.

By incorporating the cathode structure according to the invention, it is possible to realize a high-luminance and long-life color CRT free from characteristic variation.

What is claimed is:

1. A manufacturing method for a cathode structure comprising the steps of:
sintering a mixed body made of at least nickel powder and electron emission agent powder through a hot isostatic pressing process to form a sintered body;
forming a cathode pellet from the sintered body;
inserting the cathode pellet into a cup;
subjecting the cathode pellet and the cup to resistance welding with the cathode pellet and the cup clamped between upper and lower welding electrodes each having approximately the same diameter as the cathode pellet;
inserting and fixing an assembly of the cathode pellet and the cup in an end portion of a sleeve; and
inserting a heater into the sleeve.

2. A manufacturing method for a cathode structure as claimed in claim 1, wherein:
a central portion of an electron emission surface of the cathode pellet, which portion corresponds to an opening of a first grid, Is provided with an escape from the welding electrode so that the welding electrode is prevented from coming into contact with the central portion of the electron emission surface.

3. A manufacturing method for a cathode structure as claimed in claim 1, wherein:
an Insulator is embedded in a central portion of an electron emission surface of the cathode pellet, which portion corresponds to an opening of a first grid, although the same clamping pressure as that applied to a peripheral portion of the electron emission surface is applied to the central portion thereof, welding current being prevented from flowing into the central portion of the electron emission surface.

4. A manufacturing method for a cathode structure as claimed in claims 1 to 3, wherein:
the cup is made of any one kind selected from among nickel-chromium alloy, nickel-magnesium-chromium alloy, nickel-magnesium-silicon-chromium alloy, nickel-magnesium-tungsten alloy, and nickel-magnesium-silicon-tungsten alloy.

5. A color cathode ray tube provided with a cathode structure manufactured by a manufacturing method as claimed in any of claims 1 to 4.
